(19) United States
(12) Patent Application Publication
(10) Pub. No.: US 2008/0268907 A1
(43) Pub. Date: Oct. 30, 2008

(54) Switching in a Distributed Access Network

(75) Inventors: Gamini Senarath, Nepean (CA); Shalini Periyalwar, Nepean (CA); Hang Zhang, Nepean (CA); Bill Gage, Stittsville (CA); Mo-Han Fong, L'Orignal (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent, PQ (CA)

(21) Appl. No.: 11/569,988

(22) PCT Filed: Jun. 3, 2005
(86) PCT No.: PCT/IB05/01567

§ 371 Date: Dec. 4, 2006

Related U.S. Application Data
(60) Provisional application No. 60/577,362, filed on Jun. 4, 2004.
(60) Provisional application No. 60/582,298, filed on Jun. 24, 2004.
(60) Provisional application No. 60/622,946, filed on Oct. 28, 2004.

(51) Int. Cl. H04Q 7/38

(52) U.S. Cl. 455/561

(57) ABSTRACT

The present invention provides conversion between SDUs transmitted between a central network controller and base stations and PDUs transmitted between the base stations and mobile terminals. For downlink communications, SDUs are transmitted from the central network controller and forwarded to the base stations in an active set. One base station will break down the SDUs to create PDUs to transmit to the mobile terminal. For uplink communications, the base station will receive PDUs from the mobile terminal, create SDUs from the PDUs, and transmit the SDUs to the central network controller. During switching events, continuity information received from a previously serving base station is processed by the mobile terminal and used to create continuity information to send to the currently serving base station and used to determine the appropriate PDU from which to start transmissions to the mobile terminal after the switching event.

This application is a National Phase filing based on PCT/IB2005/001567, filed Jun. 3, 2005, which claims the benefit of U.S. provisional application Ser. No. 60/577,362 filed Jun. 4, 2004; U.S. provisional application Ser. No. 60/582,298 filed Jun. 24, 2004, and U.S. provisional application Ser. No. 60/622,946 filed Oct. 28, 2004, the disclosures of which are hereby incorporated by reference in their entireties.

### FIELD OF THE INVENTION

The present invention relates to wireless communications, and in particular to implementing Layer 2 processing in base stations to facilitate switching in a distributed access network.

### BACKGROUND OF THE INVENTION

In a distributed wireless access network, numerous base stations are geographically distributed and adapted to communicate with various mobile terminals. The coverage of the adjacent base stations generally overlaps. As a mobile terminal moves within a given cell supported by a base station, or from one cell to another, multiple base stations can support communications with the mobile terminal.

The wireless access network and the mobile terminal will cooperate to switch communications from one base station to another to support traffic flow. Such switching is often referred to as a “handoff.” When the base stations are switched during a communication session, integrity of the traffic flow must be maintained. In many instances, the communications may quickly switch back and forth between multiple base stations, based on channel conditions. In other instances, a more permanent transfer is involved.

Switching between base stations generally involves soft or hard switching. Soft switching involves all of the supporting base stations sending redundant data simultaneously during a transition from one base station to another. Hard switching, which includes fast cell switching (FCS) and hard handoff, involves fast and complete switching from one base station to another without transmission redundancy. Hard switching is much less resource-intensive than soft switching, but maintaining traffic flow continuity without loss has proven difficult.

At present, a central network controller, such as a base station controller, supports most Layer 2 processing by breaking down packets intended for the mobile terminal into fragments corresponding to the frames used for communicating over the radio link between the base station and the mobile terminal. Synchronization techniques for maintaining data continuity during switching require significant involvement by the central network controller, thus increasing traffic and processing overhead.

Accordingly, there is a need for a more efficient and effective hard switching technique, such as that used in fast cell selection and hard handoffs, in a distributed access network.

### SUMMARY OF THE INVENTION

The present invention provides for Layer 2 processing at each of the base stations in a distributed access network. The Layer 2 processing essentially entails conversion between service data units (SDUs) transmitted between a central network controller and the base stations and protocol data units (PDUs) wirelessly transmitted between the base stations and mobile terminals. The SDUs may correspond to a higher level data packet, such as an Internet Protocol (IP) packet, wherein the PDUs may correspond to media access control frames at the radio link protocol layer. For downlink communications, SDUs are transmitted from the central network controller and forwarded to each of the base stations in an active set of base stations, which are capable of supporting communications with a mobile terminal. Of the base stations in the active set, only one base station will communicate with the mobile terminal at any given time, and will do so by breaking down the SDUs to create PDUs for transport to the mobile terminal. For uplink communications, the base station will receive PDUs from the mobile terminal, create SDUs from the PDUs, and transmit the SDUs to the central network controller. During switching events for downlink communications, such as when switching back and forth between base stations during fast cell selection or during a hard handoff, continuity indicia received in association with the PDUs from a previously serving base station is processed by the mobile terminal and used to create continuity information to send to the currently serving base station. The currently serving base station will use the continuity information to determine the appropriate PDU from which to start transmissions to the mobile terminal after the switching event.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a communication environment according to one embodiment of the present invention.

FIG. 2 is a flow diagram illustrating basic switching according to one embodiment of the present invention.

FIG. 3 is a block representation of SDU and PDU processing and flow for a downlink embodiment of the present invention.

FIGS. 4A and 4B depict a communication flow illustrating traffic flow control for a downlink embodiment of the present invention.

FIG. 5 is a block representation of SDU and PDU processing and flow for an uplink embodiment of the present invention.

FIG. 6 is a communication flow illustrating traffic flow control for an uplink embodiment of the present invention.

FIG. 7 is a block representation of a base station according to one embodiment of the present invention.

FIG. 8 is a block representation of a mobile terminal according to one embodiment of the present invention.

FIG. 9 is a logical breakdown of a transmitter architecture according to one embodiment of the present invention.

FIG. 10 is a block representation of a receiver architecture according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

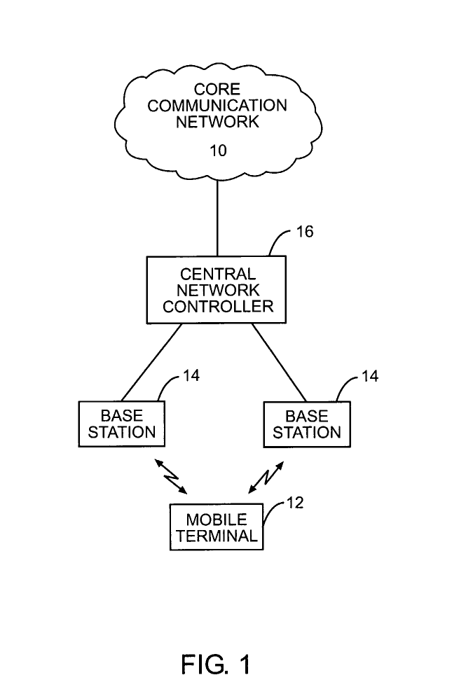

With reference to FIG. 1, a core communication network 10 is associated with a distributed wireless access network (WAN) to facilitate communications with a mobile terminal 12. The WAN includes a number of geographically distributed base stations 14, which are associated with a central network controller 16. The central network controller 16 is a logical entity, which may be implemented in various nodes or distributed among multiple nodes within the WAN. In particular, the central network controller 16 may reside in or be distributed among base stations 14, base station controllers, edge routers, digital subscriber line access modems (DSL AMs), or located in one or more nodes in the core communication network 10. Logical implementation of a central network controller 16 may also be referred to as a dynamic mobility control point or a set of dynamic mobile control points, each carrying out an identified set of mobility related functions corresponding to a given mobile terminal 12. When distributed, the location of the central network controller 16 may change from one location to another depending on the movement of a particular mobile terminal 12. In one embodiment, each mobile terminal 12 is associated with a central network controller 16. The core communication network 10 may be associated with numerous WANs, and any number of mobile terminals 12 may be within any given WAN. During communications, the mobile terminals 12 may move from being supported by one base station 14 to another, as well as move from one WAN to another.

A base station 14 may be any type of wireless access point for cellular, wireless local area network (WLAN), or other wireless communications. The communication coverage provided by each of the base stations 14 may overlap in whole or in part. As such, the mobile terminal 12 may theoretically be able to communicate with multiple base stations 14 at any given time. For the present invention, assume that traffic flow for downlink and uplink communications between the central network controller 16 and the mobile terminal 12 are primarily directed through only one base station 14 at any given time. The present invention addresses controlling traffic flow to and from the mobile terminal 12 through different base stations 14 as service for the mobile terminal 12 changes from one base station 14 to another.

Prior to delving into the details of the present invention, different data units for carrying any type of information, including audio, video, data, and voice, are defined for clarity. In general, a protocol data unit (PDU) is a packetized unit of information exchanged over a radio communication link between the base station 14 and the mobile terminal 12. In one embodiment, a PDU is exchanged between the media access control (MAC) entities in the mobile terminal 12 and the base station 14. A service data unit (SDU) is a unit of information that is generally exchanged between a base station 14 and a central network controller 16, and perhaps other entities associated with the core communication network 10. In one embodiment of the present invention, an SDU may correspond to an Internet Protocol (IP) packet or Ethernet frame. When PDUs are generally smaller than SDUs, the PDUs may represent fragmented parts of an SDU. As such, SDUs are generally exchanged between the central network controller 16 and the base station 14, and PDUs are exchanged between the base station 14 and the mobile terminal 12 to facilitate a traffic flow. The base station 14 will provide the processing, which is generally referred to as Layer 2 processing, to convert SDUs into PDUs for downlink traffic flows, and PDUs to SDUs for uplink traffic flows. In other words, an IP packet may be broken into smaller PDUs, such as radio link protocol frames, and vice versa. Those skilled in the art will recognize the various implementations of PDUs and SDUs.

In operation, an active set of base stations 14 is maintained for the mobile terminal 12 in a fast cell selection embodiment. An active set is defined as a number of base stations 14 within sufficient communication range of the mobile terminal 12. The active set is maintained at the central network controller 16 for a given mobile terminal 12, which is also aware of the base stations 14 forming the active set. In certain embodiments, the mobile terminal 12 will communicate with the central network controller 16 through an appropriate base station 14 to update the active set of base stations 14 based on the relative ability of the mobile terminal 12 to communicate with the various base stations 14. For downlink traffic flows, the central network controller 16 will receive SDUs or other information intended to be delivered to the mobile terminal 12 over a communication session. The central network controller 16 will generate SDUs intended to be delivered to the mobile terminal 12 for the communication session, and send these SDUs to each of the base stations 14 in the active set.

Since a communication session is only supported by one base station 14 at a time, the currently serving base station 14 in the active set will receive the SDUs from the central network controller 16, create PDUs from the SDUs, and forward the PDUs to the mobile terminal 12 over the established radio link. The other base stations 14 in the active set will either drop the SDUs, or if PDUs are created, drop the PDUs. Preferably, each of the base stations 14 in the active set will create PDUs in the same fashion, such that identical PDUs are created from the SDUs at each of the base stations 14 in the active set. Uplink traffic flows are supported in a similar fashion, wherein the currently serving base station 14 will, in general, receive PDUs from the mobile terminal 12 and create SDUs from the PDUs for delivery to the central network controller 16 in association with the uplink traffic flow. For uplink traffic flows, SDUs originating in an application of the mobile terminal 12 are used to create PDUs by the mobile terminal 12. The PDUs are transmitted to the base station 14, and the various PDUs associated with a given SDU may be sent to different base stations 14. Although the SDUs are usually reassembled from corresponding PDUs by the base stations 14, reassembly may take place at the central network controller 16 when the corresponding PDUs are received at different base stations 14.

As noted, various conditions may dictate that the mobile terminal 12 switch from being served by one base station 14 in the active set to another. Such switching may take place in rapid succession between any two base stations 14 or among any number of base stations 14 in the active set in a fast cell selection embodiment. As such, traffic flows will be redirected from one base station 14 to another upon switching. In a departure from existing systems, the present invention controls the continuity of the traffic flow primarily through interaction between the mobile terminal 12 and the base stations 14, wherein the central network controller 16 may provide some supplemental coordination. With prior techniques, the central network controller 16 primarily controls continuity of the traffic flow during switching. Further, prior systems have little or no support for continuity of uplink traffic flows in a fast cell selection environment.

In addition to fast cell selection, the present invention is applicable to hard handoffs, wherein essentially only one base station 14 is in the active set of base stations 14 associated with the mobile terminal 12. A connection set of base stations 14 is used for enabling hard handoffs. The connection set is similar to the active set, but is maintained only by the central network controller 16, and not the mobile terminal 12. A hard handoff can be used to implement a network-assisted handover, such as that used in the IEEE 802.16e standards, by selectively forwarding downlink SDUs to multiple base stations 14. The connection set may be a subset or superset of the active set used for fast cell selection. The central network controller 16 may replicate and forward SDUs to only base stations 14 in the connection set. Further, the central network controller 16 may forward SDUs to base stations 14 that may potentially serve the mobile terminal 12 in the future, in order to avoid delays in the handoff. In contrast, the central network controller 16 may simply selectively forward SDUs to only a subset of the active set of base stations 14, to minimize costs associated with backhauling all the replicated data information.

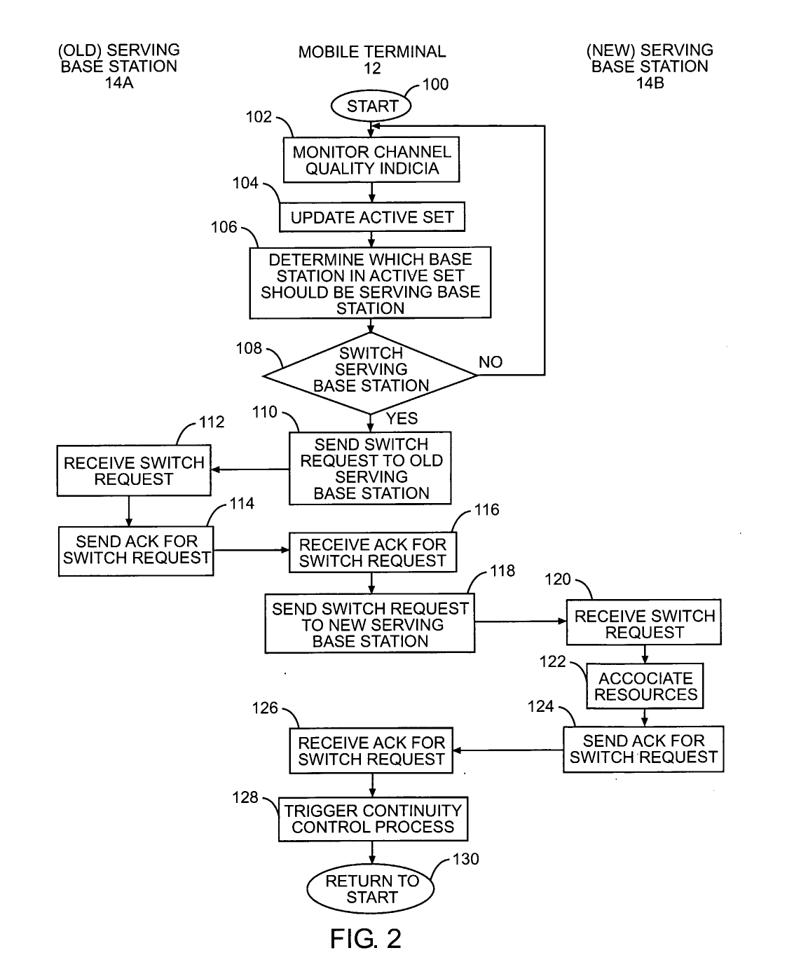

Prior to describing how continuity is maintained for downlink and uplink traffic flows, a high-level overview of one exemplary switching process is provided in association with FIG. 2. In general, the mobile terminal 12 will switch from one base station 14 to another at one level, and control data continuity corresponding to the switching at another level. The switching process starts (step 100) when the mobile terminal 12 monitors channel quality indicia indicative of the relative quality of the communication channel between the mobile terminal 12 and the various base stations 14 within communication range of the mobile terminal 12 (step 102). Based on the channel quality indicia, the mobile terminal 12 may communicate with the central network controller 16 to update the active set of base stations 14 that represent those base stations 14 at which channel quality indicia indicates communications can be reasonably supported (step 104). Next, the mobile terminal 12 can determine which base station 14 in the active set should be the serving base station (step 106). If the selected base station 14 is different from the currently serving base station, the mobile terminal 12 will determine whether to switch from the currently serving base station 14 to another base station 14 (step 108). If switching is not necessary, the process will repeat, wherein the mobile terminal 12 will monitor channel quality, update the active set of base stations 14, and again determine whether switching is necessary. The decision to switch between base stations 14 may be based on one or more criteria. The criteria may include channel quality estimates from one or more base stations 14, mobile velocity, the amount of data to be transmitted in the uplink or downlink direction, the existing load at the various base stations 14, service and traffic flow requirements such as quality of service, delay, packet loss, and transfer rate, as well as service type. Those skilled in the art will recognize other criteria that may be used alone or in combination to make decisions regarding control switching.

If switching is warranted (step 108), the mobile terminal 12 may send a switch request to the currently serving (old) base station 14A to indicate a need to switch to another (new) base station 14B (step 110). The old serving base station 14A will receive the switching request (step 112), process the switching request accordingly, and send an acknowledgement (ACK) for the switch request back to the mobile terminal 12 (step 114). The mobile terminal 12 will receive the ACK for the switch request (step 116) and will then send another switch request to what will become the new serving base station 14B (step 118). The new serving base station 14B will receive the switch request (step 120), allocate resources for communications (step 122), and send an ACK for the switch request back to the mobile terminal 12 (step 124). The mobile terminal 12 will receive the ACK for the switch request from the new serving base station 14B (step 126) and trigger the continuity control process of the present invention (step 128), wherein the overall process begins anew (step 130). At this point, the traffic flow for the mobile terminal 12 will switch from being directed solely through the old serving base station 14A to the new serving base station 14B.

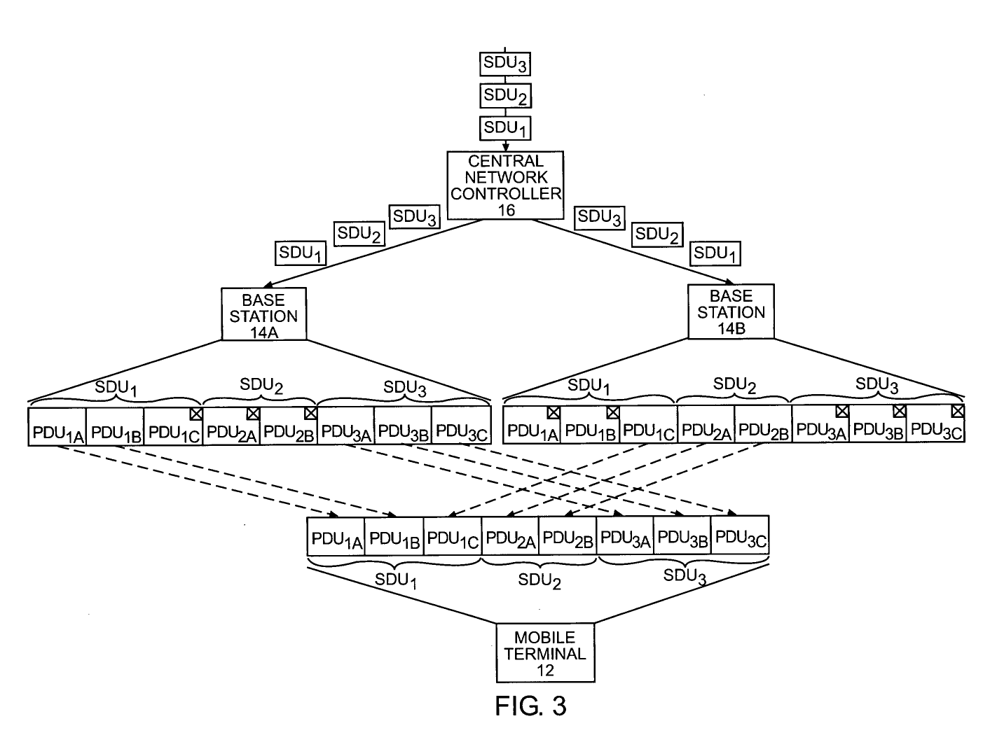

In reference to FIG. 3, a downlink traffic flow is illustrated according to one embodiment of the present invention. As illustrated, SDUs (SDU₁, SDU₂, and SDU₃) are received by the central network controller 16 and multicast to the base stations 14A and 14B in the active set of base stations 14 serving the mobile terminal 12. Each of the base stations 14 may provide processing of the SDUs to create corresponding PDUs. SDU₁ is fragmented into PDU_{1A}, PDU_{1B}, and PDU_{1C}; SDU₂ is fragmented into PDU_{2A} and PDU_{2B}; and SDU₃ is fragmented into PDU_{3A}, PDU_{3B}, and PDU_{3C}. Whether the processing of the SDUs into PDUs happens in a continuous fashion or only as needed by the non-serving base stations 14 in the active set, the processing may be synchronized, especially if continuity is kept within PDUs. If continuity is only kept within SDUs, the different base stations 14 in the active set may carry out different processing to create different PDUs for a given SDU.

Assuming that the base stations 14A and 14B of the active set provide the same Layer 2 processing of the SDUs, the same PDUs can be created at the different base stations 14A and 14B. Assume that base station 14A is the originally serving base station, and is able to transmit PDU_{1A} and PDU_{1B} of SDU₁ prior to a switching event. After the switching event, base station 14B maintains continuity of the traffic flow by transmitting PDU_{1C}, the remaining PDU for SDU₁, and then transmits PDU_{2A} and PDU_{2B} of SDU₂ prior to another switching event. Assuming the switching event sends support of the mobile terminal 12 back to base station 14A, base station 14A will send PDU_{3A}, PDU_{3B}, and PDU_{3C} of SDU₃. The PDUs illustrated with an X are not transmitted by the corresponding base station 14A or 14B. They are shown merely to illustrate how continuity is maintained at the mobile terminal 12 by the base stations 14A and 14B.

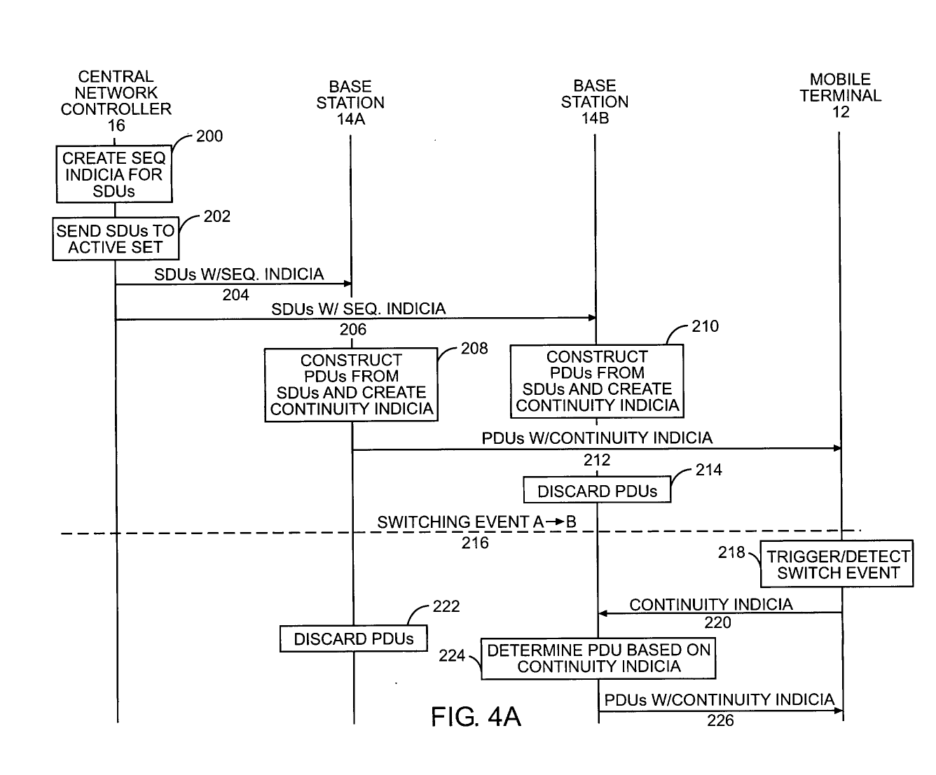

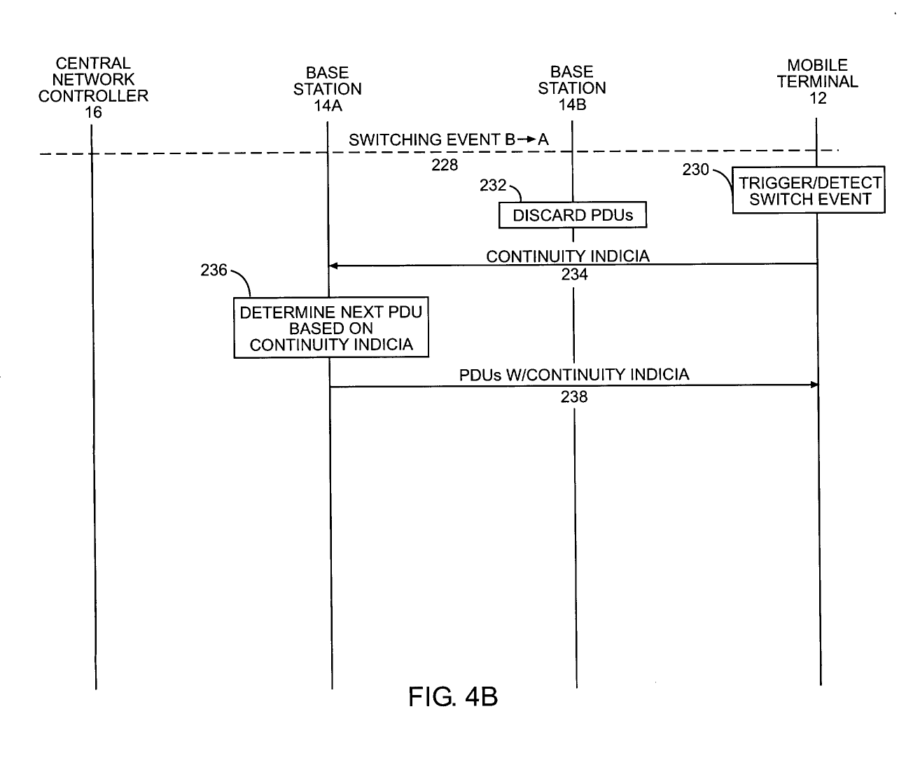

Turning now to FIGS. 4A and 4B, an exemplary communication flow for a downlink traffic flow is provided according to one embodiment of the present invention. Notably, the communication flow is provided at a high level, wherein concepts may be implemented in a variety of ways, and most signaling information is not illustrated in order to improve clarity and understanding of the inventive concepts. Initially, information and perhaps SDUs are received by the central network controller 16 and are intended for the mobile terminal 12. The central network controller 16 may create sequence indicia for the SDUs to be delivered to the mobile terminal 12 (step 200). Unique sequence indicia may be provided for each SDU, and may identify a relative placement of the SDU in the traffic flow. Further, the sequence number may identify internal ordering of information provided in the SDU, in case the SDU is fragmented or otherwise broken into smaller units during transmission to the mobile terminal 12. The central network controller 16 will then identify the active set of base stations 14A and 14B for the mobile terminal 12 and send the SDUs to the base stations 14 in the active set (step 202). The SDUs with the corresponding sequence indicia are then sent to the base stations 14A and 14B of the active set (steps 204 and 206). The base stations 14A and 14B may then process the SDUs and construct PDUs from the SDUs and create continuity indicia associated with the PDUs (steps 208 and 210).

Notably, all of the active base stations 14 may be configured to create the PDUs from the SDUs in an identical fashion. The continuity indicia is the same as or analogous to the sequence indicia, and relates to identifying and perhaps providing a relative order of the PDUs. The continuity indicia for a particular PDU may include the SDU sequence indicia identifying the SDU from which the PDU was created, as well as grouping information identifying the particular fragment of the SDU corresponding to the PDU. The grouping information may be a byte offset, block number, or the like.

Assume that base station 14A is the currently serving base station for the mobile terminal 12. At this point, the serving base station 14A will send the PDUs, perhaps with the continuity indicia, to the mobile terminal 12 to facilitate the traffic flow (step 212). The continuity indicia may be sent in the PDUs as additional header information, or in separate control or signaling messages. As will be discussed below, the continuity indicia may be sent in association with each PDU transmitted, for a group of PDUs, or prior to or in association with a switching event. The base station 14B, which is not the serving base station for the mobile terminal 12, will discard the PDUs (step 214). The continuity indicia may be incorporated into a header of the PDUs, and thus sent with each PDU. Alternatively, the continuity indicia may be sent in separate signaling messages in a continuous or periodic fashion. Notably, certain embodiments do not require the continuity indicia to be sent with each PDU, and in such cases it will only be sent when the continuity indicia is needed to facilitate switching. Delivery of the continuity information may depend on whether the PDUs are delivered in an automated retransmission request (ARQ) environment or a non-ARQ environment. Further details will be provided below.

Regardless of an ARQ or non-ARQ embodiment, the mobile terminal 12 will receive the PDUs and continuity indicia on an ongoing basis or as needed. Upon the occurrence of a switching event where the mobile terminal 12 switches from using base station 14A to using base station 14B as the serving base station (step 216), the mobile terminal 12 will either trigger or detect the switching event (step 218) and send the appropriate continuity indicia to the new serving base station 14B (step 220). In the meantime, the base station 14A will start to discard the PDUs (step 222) instead of transmitting them to the mobile terminal 12.

The new serving base station 14B will determine the appropriate PDU to send to the mobile terminal 12 based on the continuity indicia received from the mobile terminal 12 (step 224) in order to maintain continuity of the traffic flow, then begin delivering the PDUs, perhaps including or along with the continuity indicia, to the mobile terminal 12 (step 226). If another switching event takes place, wherein the serving base station should be changed from base station 14B to base station 14A (step 228), the mobile terminal 12 will either trigger or detect the switching event (step 230) and base station 14B will discard the PDUs to be sent to the mobile terminal 12 (step 232). The mobile terminal 12 will send continuity indicia to base station 14A (step 234), which will use the continuity indicia to determine the PDU to send to the mobile terminal 12 to maintain continuity and the traffic flow (step 236). At this point, base station 14A will begin sending the next PDU and the following PDUs, perhaps along with the continuity indicia, to the mobile terminal 12 (step 238).

The above communication flow illustrates one of the basic concepts of one embodiment of the present invention. This concept allows the base stations 14 to provide construction of the PDUs from the SDUs received from the central network controller 16 and provide the PDUs to the mobile terminal 12 in association with continuity indicia. During a switching event, the mobile terminal 12 will send continuity indicia to the base station 14 to which support is being switched. The continuity indicia sent to the base station 14 allows the base station 14 to determine the appropriate PDU to send in order to maintain continuity in the communication flow. The first PDU sent by the newly serving base station 14 will preferably be the next PDU in the traffic flow. This appropriate PDU may be a PDU that was never sent by the previously serving base station 14, or one that was sent and lost or otherwise not properly received by the mobile terminal 12. Accordingly, the continuity indicia may trigger the newly serving base station 14 to retransmit PDUs, if necessary or desired. As such, the base stations 14 and the mobile terminal 12 provide the predominant role in maintaining continuity of traffic flows during switching events.

The basic delivery of PDUs between base stations 14 and the mobile terminal 12 are categorized as either being ARQ-based or non-ARQ-based. ARQ-based communications generally require an acknowledgement (ACK) for successfully received PDUs, or a negative acknowledgement (NAK) if the receiving entity, either the base station 14 or the mobile terminal 12, determines that a PDU is lost. For downlink traffic flows in an ARQ-based system, the mobile terminal 12 understands when a PDU is lost, and a point in the traffic flow up to which traffic was correctly received. The mobile terminal 12 also knows essentially what information was not received correctly, at any given time during a traffic flow, because the continuity information is provided in, with, or in association with the PDUs. As such, the continuity information provided in association with the PDUs allows the mobile terminal 12 to identify the last PDU that was correctly received, and provide information to the newly serving base station 14 that is indicative of the next PDU in the traffic flow that needs to be transmitted by the base station 14. The continuity information may identify the last packet that was properly received by the mobile terminal 12, the next packet with that the mobile terminal 12 expected, or the like. Those skilled in the art will recognize that the continuity indicia may specifically identify different entities, but will still allow the base station 14 to determine the next PDU in the traffic flow that needs to be transmitted to the mobile terminal 12. ARQ-based scenarios are generally used in situations where information in the traffic flow is not time-sensitive, but is sensitive to loss. File transfer or other data-based information is generally sent in ARQ-based scenarios.

In contrast, non-ARQ-based scenarios are more time sensitive, and less sensitive to making sure that every bit of data is properly received. In a non-ARQ scenario, the mobile terminal 12 will likely not receive continuity indicia in the headers of the PDUs. There may be basic sequencing information to enable proper ordering of the overall SDUs that the PDUs will form. Thus, once the SDUs are reassembled at the mobile terminal 12, the overall sequencing provided by the central control controller 16 may be available to the mobile terminal 12, but sequencing information is generally not the continuity information used to help determine if a PDU is lost or, more importantly, which PDU needs to be sent by the newly serving base station 14 after a switching event. Accordingly, prior to the actual switching event, the originally serving base station 14 will send continuity indicia allowing the mobile terminal 12 to determine how to tell the newly serving base station 14 which PDU to send to maintain continuity of the traffic flow. Continuity information pertaining to maintaining continuity of the traffic flow is thus received at the mobile terminal 12 from the originally serving base station 14, processed by the mobile terminal 12, and sent to the newly serving base station 14 to maintain continuity of the traffic flow.

The primary difference in the ARQ and non-ARQ scenarios is how and how often continuity information is provided to the mobile terminal 12 in association with transmission of PDUs. In a non-ARQ scenario, the originally serving base station 14 may send the continuity information in a PDU that still needs to be sent to the mobile terminal 12 prior to switching. Alternatively, the originally serving base station 14 may send the continuity information in a separate message, which may be explicitly for continuity information or integrated with another control or signaling message. In either case, continuity information associated with PDUs sent to the mobile terminal 12 is provided to the mobile terminal 12 and then relayed to the newly serving base station 14 to maintain continuity of the traffic flow.

The continuity information may be provided to the newly serving base station 14 from the mobile terminal 12 in a variety of ways. Further, continuity information may identify the next PDU that needs to be sent by identifying an SDU sequence number and associated block number, byte offset, or the like for the last received PDU or the next PDU that needs to be received. The continuity information in an ARQ-based scenario may be included in the acknowledgement or negative acknowledgement, which may be received by all of the base stations 14 in the active set. The continuity information may be provided in a special control or signaling message or embedded in an existing signaling or control message. These messages may be monitored by all of the base stations 14 in the active set, or simply by the newly serving base station. These messages may be automatically sent by the mobile terminal 12, or in response to the newly serving base station 14 polling the mobile terminal 12 to provide the continuity information after switching. Alternatively, the originally serving base station 14 may send continuity information directly to the newly serving base station 14. This backhaul technique between the base stations 14 may suffer from extended delay due to the messaging requirements within the WAN.

The continuity information may take many forms and may be used in different ways. In certain embodiments, switching is implemented such that continuity of the traffic flow requires transmission of all the PDUs associated with a given SDU. Accordingly, if only one of three PDUs associated with an SDU is received from the previously serving base station 14, the new base station 14 will retransmit all of the PDUs associated with the SDU after switching occurs. In such an embodiment, the sequence numbers associated with the SDUs may be the actual continuity information, and PDU-level continuity information, such as block number or byte offset is not necessary, since continuity information is on a per-SDU basis. Other embodiments may provide sequence indicia or continuity indicia corresponding to a byte offset from a given reference point, which may be the start of a communication session. The central network controller 16 may provide the byte offset information and update newly added base stations 14 to an active set with the current offset information. Further, the central network controller 16 may provide sequence indicia in SDUs sent to the base stations 14 in order to help synchronize base stations 14 in an active set. This scenario is most beneficial when the block sizes for the SDUs are fixed during the communication session, thereby allowing the central network controller 16 to keep track of the current block numbers and forward them accordingly.

Each of the base stations 14 in an active set of base stations 14 for a mobile terminal 12 will include a buffer for SDUs, PDUs, or both. In general, the base stations 14 in the active set that are not currently serving the mobile terminal 12 will discard SDUs, and PDUs if concurrent processing is implemented, after a certain period of time. Further, a flow control mechanism may be placed in association with a central entity or the base stations 14 in the active set, such that not more than a certain amount of data will be sent to the base station 14 from the central network controller 16 to ensure that the buffers are not overloaded. Accordingly, those base stations 14 that are in the active set but not serving the mobile terminal 12 will only have to keep a limited amount of data before discarding. Further, the base stations 14 may signal one another after a successful transmission or a number of successful transmissions to trigger clearing of the buffers in the active set of base stations 14. Alternatively, the currently serving base station 14 may provide indication to the central network controller 16 of successful downlink transmissions to the mobile terminal 12. The central network controller 16 can then provide this information to the other base stations 14 in the active set. The information can be sent in the SDUs or other signaling. When a base station 14 is taken out of an active set for the mobile terminal 12, the buffer can be immediately cleared.

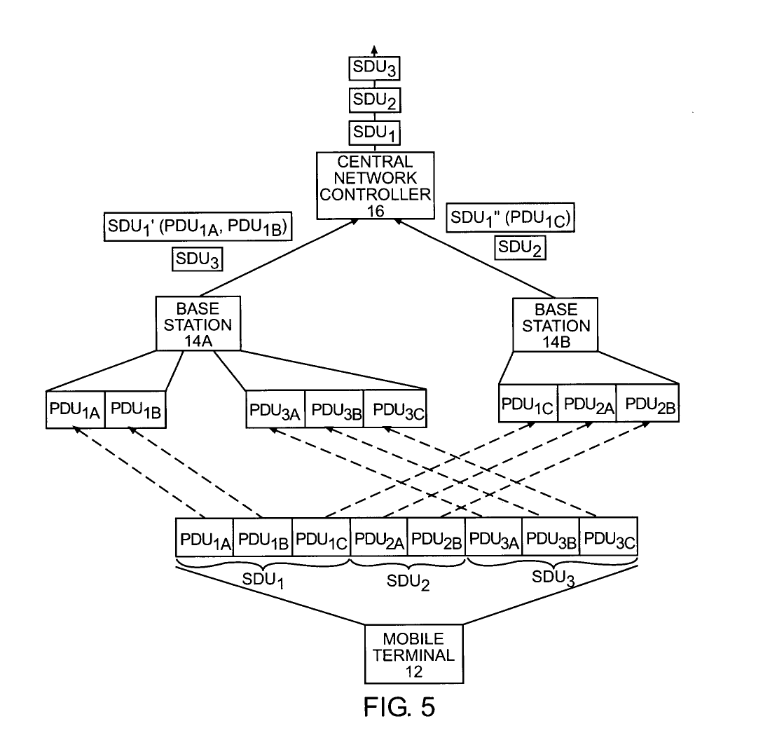

For uplink traffic flows from the mobile terminal 12 to the central network controller 16, the Layer 2 processing provided for downlink traffic flows is essentially reversed in the base stations 14 and the mobile terminal 12. With reference to FIG. 5, an exemplary uplink traffic flow is provided. Assume that the mobile terminal 12 generates the three SDUs SDU₁, SDU₂, and SDU₃, which are generally described above, and breaks the respective SDUs into PDUs PDU_{1A}, PDU_{1B}, and PDU_{1C}; PDU_{2A} and PDU_{2B}; and PDU_{3A}, PDU_{3B}, and PDU_{3C}, respectively. As illustrated, the mobile terminal 12 will send PDU_{1A} and PDU_{1B} to base station 14A prior to a switching event, wherein PDU_{1C}, PDU_{2A}, and PDU_{2B} are sent to base station 14B. A subsequent switching event then triggers the mobile terminal 12 to send PDU_{3A}, PDU_{3B}, and PDU_{3C} to base station 14A. Notably, the PDUs for SDU₁ are sent to different base stations 14A and 14B. In particular, PDU_{1A} and PDU_{1B} are sent to base station 14A, and PDU_{1C} is sent to base station 14B. In one embodiment, the base stations 14A and 14B will attempt to reassemble the SDUs from the corresponding PDUs, if possible, and send the SDUs to the central network controller 16.

When a given base station 14 does not receive all of the PDUs for a given SDU, several options are available. As illustrated, complete SDUs are sent to the central network controller 16. Incomplete SDUs, including all of the PDUs received for a particular SDU, are also sent to the central network controller 16, which will reassemble all of the partial SDUs, such as SDU₁′ (PDU_{1A}, PDU_{1B}) and SDU₁″ (PDU_{1C}), and create the appropriate SDU₁. Accordingly, SDU assembly from PDUs will primarily take place at the base stations 14, when appropriate, and partial SDUs will be reassembled at the central network controller 16. Alternatively, the base stations 14A and 14B may communicate with each other such that the originally serving base station 14 will provide the fragmented portion of an SDU to the currently serving base station 14, such that the currently serving base station 14 can reassemble the SDU and deliver it to the central network controller 16. A corollary may occur wherein the newly serving base station 14 sends fragmented information for an SDU to the originally serving base station 14, which will create the SDU and provide it to the central network controller 16. In other embodiments, all of the PDUs associated with a given SDU must be transmitted to a single base station 14, wherein when all of the PDUs associated with an SDU are not received by a base station 14, the mobile terminal 12 will send all of the PDUs associated with the fragmented SDU to the newly serving base station 14, which will recreate the SDU and forward it to the central network controller 16.

In an ARQ-based scenario, the mobile terminal 12 will retransmit unsuccessfully received PDUs for all the PDUs associated with an SDU in which one of the PDUs was not properly received. The serving base station 14 can provide reception status for uplink data flows to the mobile terminal 12 in several ways. The status can be embedded into PDUs in the downlink traffic flow, in a separate control or signaling message, such as an ACK or NAK message or other specifically designed message for this purpose. Status may be provided to the mobile terminal 12 by the serving base station 14 in a continuous fashion, or only when deemed necessary, such as prior to switching. Any continuity information associated with the PDUs in the uplink traffic flow can be sent in the PDUs or in separate signaling or control messages in a continuous fashion, or only when necessary, such as right after switching. Again, the continuity information will be sent to the newly serving base station 14. If the mobile terminal 12 does not receive an ACK from a previously serving base station 14, the mobile terminal 12 can consider the PDU or SDU lost, and will retransmit the lost PDU or all of the PDUs associated with the SDU. Accordingly, the ACKs may come in response to each PDU, a group of PDUs, or the PDUs associated with a particular SDU. In one embodiment, ACKs sent by the previously serving base station 14 prior to switching may be sent directly over the WAN to the newly serving base station 14, which will forward these ACKs to the mobile terminal 12. Although delays may be instilled in the process, the mobile terminal 12 will not need to retransmit the PDUs associated with the ACKs in case these ACKs were simply not received by the mobile terminal 12 due to channel conditions.

For non-ARQ-based systems, the continuity information is provided in a similar fashion. For example, the continuity information may be sent by the mobile terminal 12 in every PDU in the uplink traffic flow or only when necessary, such as right before and after switching. The data continuity information can be sent within the PDU or through a special or existing control or signaling message.

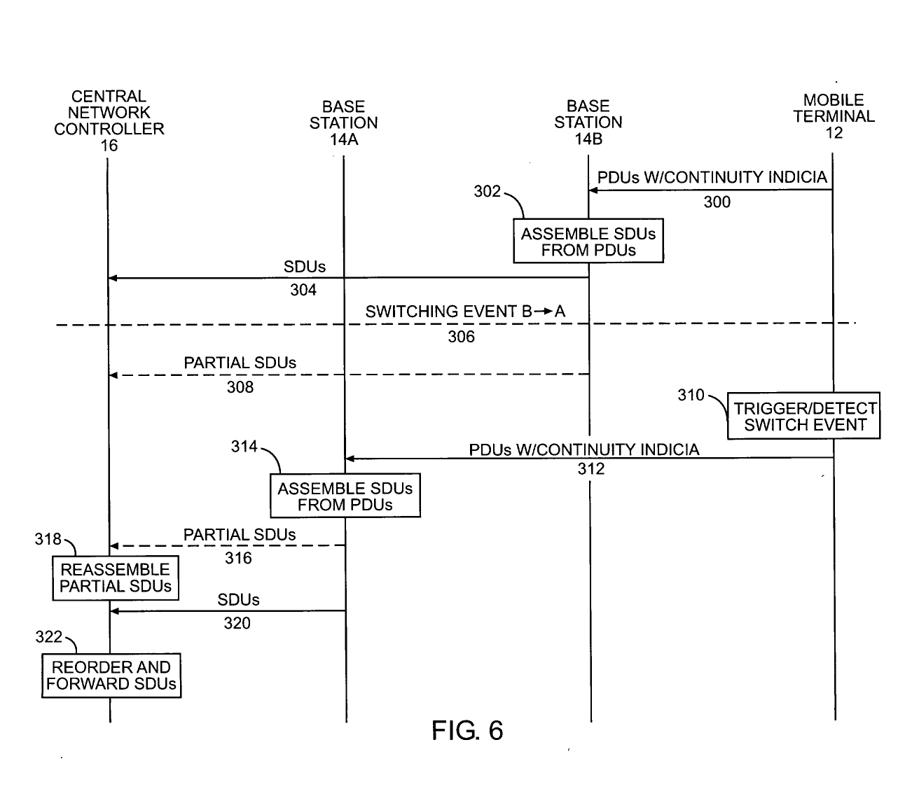

Turning now to FIG. 6, an exemplary uplink traffic flow is provided. Assume that base station 14B is the currently serving base station 14 in an active set of base stations 14 including base stations 14A and 14B. Initially, assume the mobile terminal 12 creates PDUs from corresponding SDUs and provides the PDUs to base station 14B in association with continuity indicia (step 300). Again, continuity indicia may be imbedded in each PDU, or may be sent in association with the PDUs on a continuous, periodic, or as-needed basis. The base station 14B will assemble the SDUs from the PDUs (step 302) and forward the SDUs to the central network controller 16 (step 304). Assume a switching event occurs that triggers the mobile terminal 12 to switch from base station 14B to base station 14A (step 306). Base station 14B will send any partial SDUs, which may be the properly received PDUs for a given SDU, to the central network controller 16 (step 308). The mobile terminal 12 will either trigger the switching event or detect the switching event (step 310) and begin sending PDUs along with associated continuity indicia to the new serving base station 14A (step 312). Base station 14A will then begin assembling SDUs from the PDUs (step 314). Any partial SDUs will be sent to the central network controller 16 (step 316), which will reassemble the partial SDUs from the information received from base station 14B and base station 14A (step 318). The central network controller 16 will also receive the current stream of SDUs from base station 14A (step 320) and then proceed to reorder and forward all of the SDUs over the core communication network 10 toward their intended destination (step 322).

As noted above, the base stations 14A and 14B may be configured not to forward partial SDUs to the central network controller 16, and as such may require the mobile terminal 12 to retransmit all the PDUs associated with a given SDU to a single base station 14, which will fully assemble the SDU from the PDUs and send the SDU to the central network controller 16. In general, the present invention attempts to maximize Layer 2 processing at the base stations 14 and will attempt to reassemble SDUs from the PDUs received from the mobile terminal 12 and provide these PDUs to the central network controller 16. Again, the backhauling of information from the previously serving base station 14 and the currently serving base station 14 may be provided to exchange the PDUs necessary to provide one of the base stations 14 with all of the PDUs associated with a given SDU, such that the SDU can be reassembled and sent to the central network controller 16.

Accordingly, the present invention allows Layer 2 processing to occur at the base stations 14 for uplink and downlink traffic flows. Further, these base stations 14 may provide independent scheduling of radio link resources with the mobile terminals 12 as well as provide independent management of the transmit and receive windows for retransmitting PDUs or other information. These aspects of the present invention are applicable to fast cell selection, as well as hard handoffs, and may be implemented in any number of cellular or wireless LAN based applications, including those outlined in the IEEE's 802.16e.

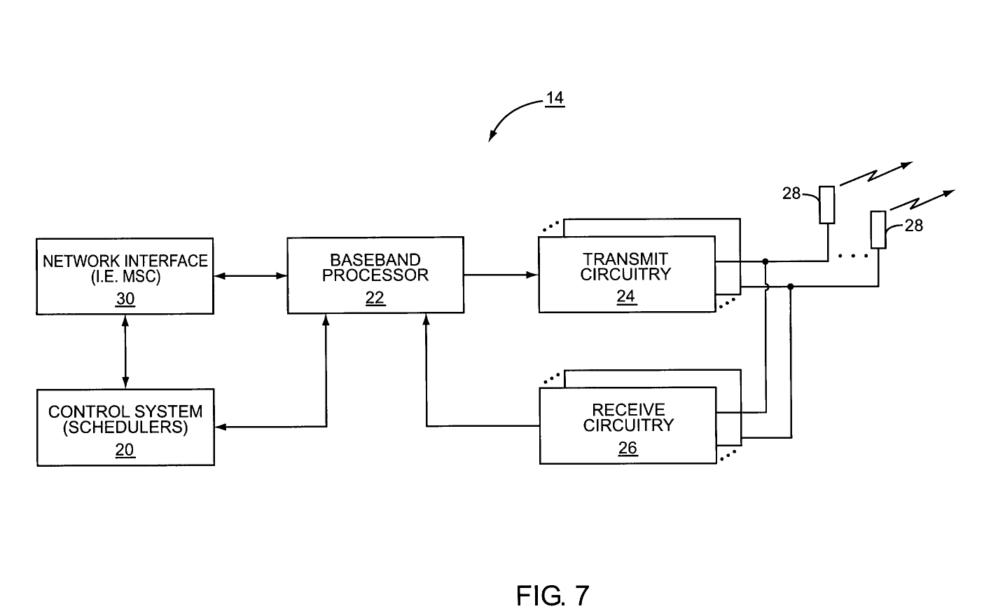

With reference to FIG. 7, a base station 14 configured according to one embodiment of the present invention is illustrated. The base station 14 generally includes a control system 20, a baseband processor 22, transmit circuitry 24, receive circuitry 26, multiple antennas 28, and a network interface 30. The receive circuitry 26 receives radio frequency signals through antennas 28 bearing information from one or more remote transmitters provided by mobile terminals 12. Preferably, a low noise amplifier and a filter (not shown) cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs). The received information is then sent across a wireless network via the network interface 30 or transmitted to another mobile terminal 12 serviced by the base station 14. The network interface 30 will typically interact with the central network controller 16 and a circuit-switched network forming a part of a wireless network, which may be coupled to the public switched telephone network (PSTN).

On the transmit side, the baseband processor 22 receives digitized data, which may represent voice, data, or control information, from the network interface 30 under the control of control system 20, and encodes the data for transmission. The encoded data is output to the transmit circuitry 24, where it is modulated by a carrier signal having a desired transmit frequency or frequencies. A power amplifier (not shown) will amplify the modulated carrier signal to a level appropriate for transmission, and deliver the modulated carrier signal to the antennas 28 through a matching network (not shown). The multiple antennas 28 and the replicated transmit and receive circuitries 24, 26 provide spatial diversity. Modulation and processing details are described in greater detail below.

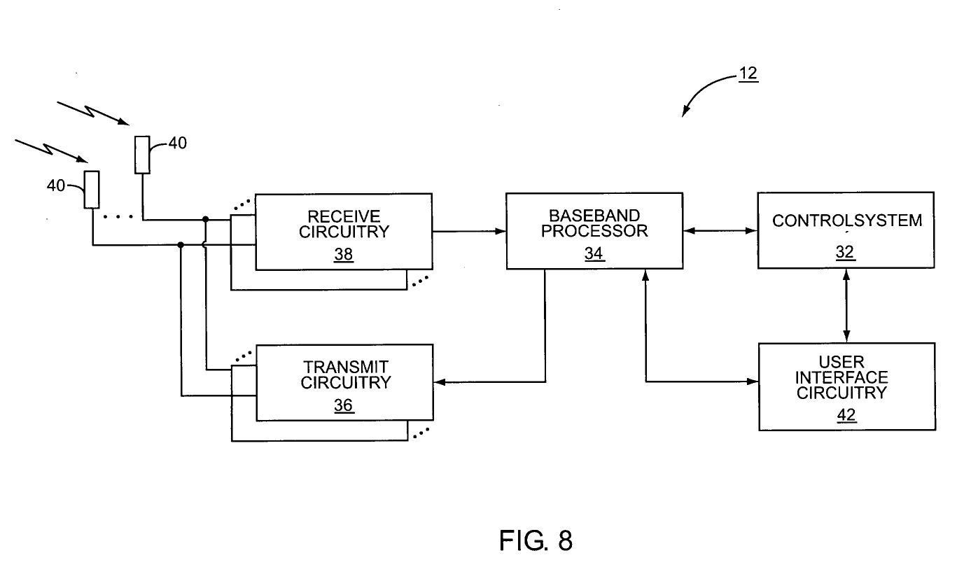

With reference to FIG. 8, a mobile terminal 12 configured according to one embodiment of the present invention is illustrated. Similarly to the base station 14, the mobile terminal 12 will include a control system 32, a baseband processor 34, transmit circuitry 36, receive circuitry 38, multiple antennas 40, and user interface circuitry 42. The receive circuitry 38 receives radio frequency signals through antennas 40 bearing information from one or more base stations 14. Preferably, a low noise amplifier and a filter (not shown) cooperate to amplify and remove broadband interference from the signal for processing. Downconversion and digitization circuitry (not shown) will then downconvert the filtered, received signal to an intermediate or baseband frequency signal, which is then digitized into one or more digital streams. The baseband processor 34 processes the digitized received signal to extract the information or data bits conveyed in the received signal. This processing typically comprises demodulation, decoding, and error correction operations, as will be discussed in greater detail below. The baseband processor 34 is generally implemented in one or more digital signal processors (DSPs) and application specific integrated circuits (ASICs).

For transmission, the baseband processor 34 receives digitized data, which may represent voice, data, or control information, from the control system 32, which it encodes for transmission. The encoded data is output to the transmit circuitry 36, where it is used by a modulator to modulate a carrier signal that is at a desired transmit frequency or frequencies. A power amplifier (not shown) will amplify the modulated carrier signal to a level appropriate for transmission, and deliver the modulated carrier signal to the antennas 40 through a matching network (not shown). The multiple antennas 40 and the replicated transmit and receive circuitries 36, 38 provide spatial diversity. Modulation and processing details are described in greater detail below.

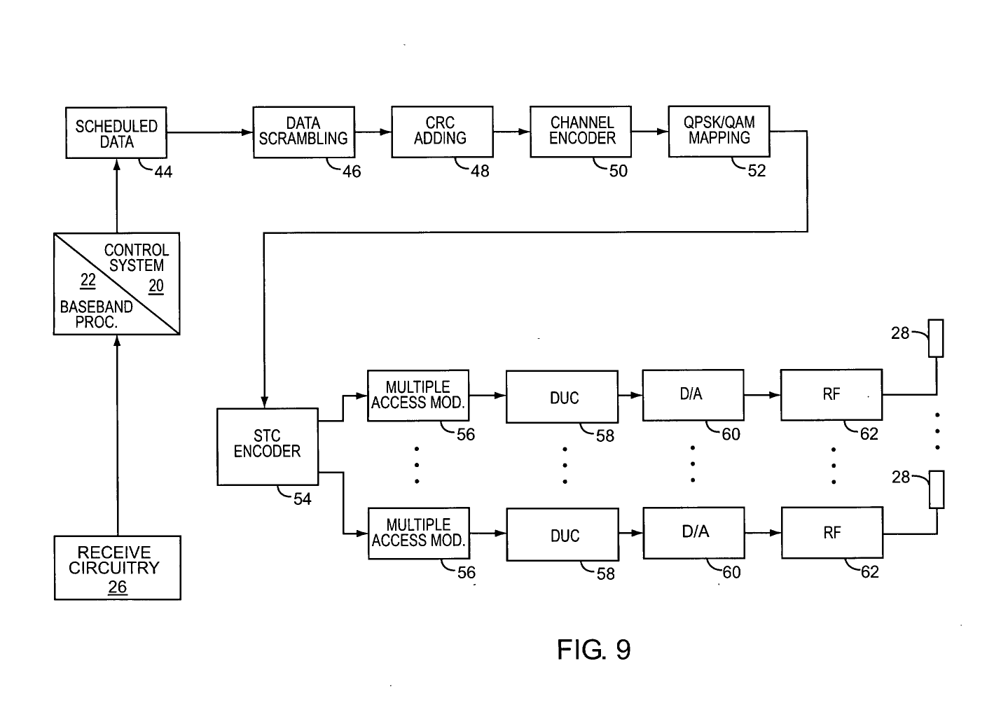

With reference to FIG. 9, a logical transmission architecture is provided according to one embodiment. The transmission architecture is described as being that of the base station 14, but those skilled in the art will recognize the applicability of the illustrated architecture for both uplink and downlink communications. Further, the transmission architecture is intended to represent a variety of multiple access architectures, including, but not limited to code division multiple access (CDMA), frequency division multiple access (FDMA), time division multiple access (TDMA), and orthogonal frequency division multiplexing (OFDM).

Initially, the central network controller 16 sends data (SDUs) intended for a mobile terminal 12 to the base station 14 for scheduling. The scheduled data 44, which is a stream of bits, is scrambled in a manner reducing the peak-to-average power ratio associated with the data using data scrambling logic 46. A cyclic redundancy check (CRC) for the scrambled data is determined and appended to the scrambled data using CRC adding logic 48. Next, channel coding is performed using channel encoder logic 50 to effectively add redundancy to the data to facilitate recovery and error correction at the mobile terminal 12. The channel encoder logic 50 uses known Turbo encoding techniques in one embodiment.

The resultant data bits are systematically mapped into corresponding symbols depending on the chosen baseband modulation by mapping logic 52. Preferably, a form of Quadrature Amplitude Modulation (QAM) or Quadrature Phase Shift Key (QPSK) modulation is used. At this point, groups of bits have been mapped into symbols representing locations in an amplitude and phase constellation. Blocks of symbols are then processed by space-time code (STC) encoder logic 54. The STC encoder logic 54 will process the incoming symbols according to a selected STC encoding mode and provide N outputs corresponding to the number of transmit antennas 28 for the base station 14. At this point, assume the symbols for the N outputs are representative of the data to be transmitted and capable of being recovered by the mobile terminal 12. Further detail is provided in A. F. Naguib, N. Seshadri, and A. R. Calderbank, “Applications of space-time codes and interference suppression for high capacity and high data rate wireless systems,” Thirty-Second Asilomar Conference on Signals, Systems & Computers, Volume 2, pp. 1803-1810,1998; R. van Nee, A. van Zelst and G. A. Atwater, “Maximum Likelihood Decoding in a Space Division Multiplex System”, IEEE VTC. 2000, pp. 6-10, Tokyo, Japan, May 2000; and P. W. Wolniansky et al., “V-BLAST: An Architecture for Realizing Very High Data Rates over the Rich-Scattering Wireless Channel,” Proc. IEEE ISSSE-98, Pisa, Italy, Sep. 30, 1998 which are incorporated herein by reference in their entireties.

For illustration, assume the base station 14 has two antennas 28 (N=2) and the STC encoder logic 54 provides two output streams of symbols. Accordingly, each of the symbol streams output by the STC encoder logic 54 is sent to a corresponding multiple access modulation function 56, illustrated separately for ease of understanding. Those skilled in the art will recognize that one or more processors may be used to provide such analog or digital signal processing alone or in combination with other processing described herein. For example, the multiple access modulation function 56 in a CDMA function would provide the requisite PN code multiplication, wherein an OFDM function would operate on the respective symbols using inverse discrete Fourier transform (IDFT) or like processing to effect an Inverse Fourier Transform. Attention is drawn to co-assigned application Ser. No. 10/104,399, filed Mar. 22, 2002, entitled SOFT HANDOFF FOR OFDM, for additional OFDM details, and to RF Microelectronics by Behzad Razavi, 1998 for CDMA and other multiple access technologies, both of which are incorporated herein by reference in their entireties.

Each of the resultant signals is up-converted in the digital domain to an intermediate frequency and converted to an analog signal via the corresponding digital up-conversion (DUC) circuitry 58 and digital-to-analog (D/A) conversion circuitry 60. The resultant analog signals are then simultaneously modulated at the desired RF frequency, amplified, and transmitted via RF circuitry 62 and antennas 28. Notably, the transmitted data (PDUs) may be preceded by pilot signals, which are known by the intended mobile terminal 12. The mobile terminal 12, which is discussed in detail below, may use the pilot signals for channel estimation and interference suppression and the header for identification of the base station 14.

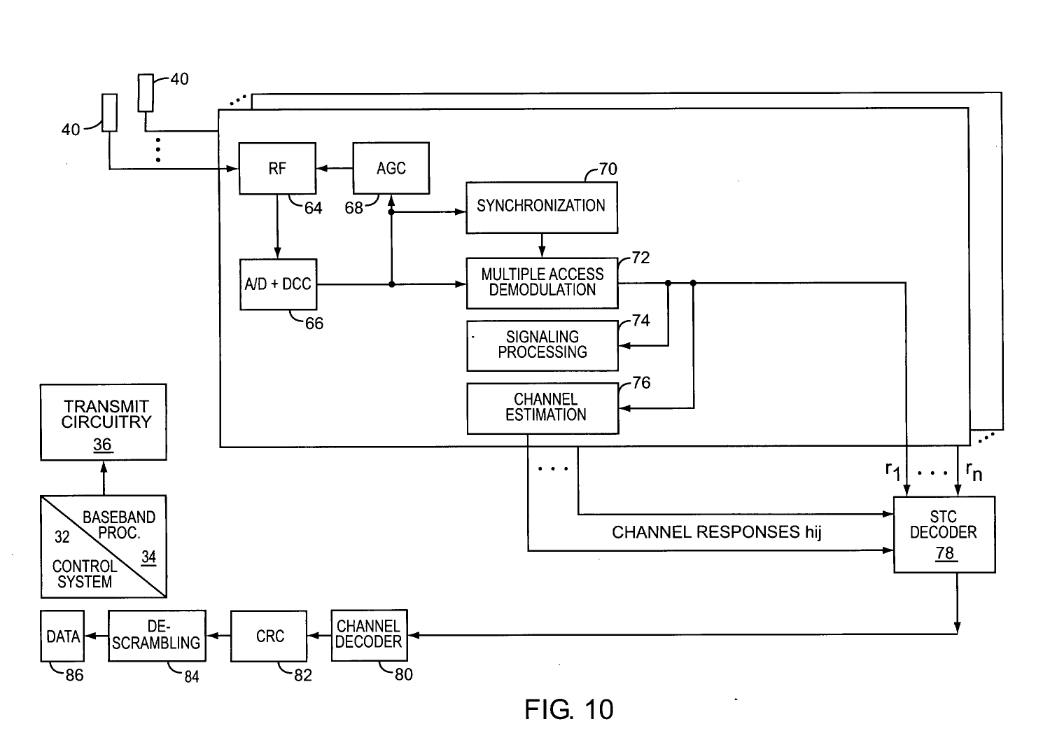

Reference is now made to FIG. 10 to illustrate reception of the transmitted signals by a mobile terminal 12. Upon arrival of the transmitted signals at each of the antennas 40 of the mobile terminal 12, the respective signals are demodulated and amplified by corresponding RF circuitry 64. For the sake of conciseness and clarity, only one of the multiple receive paths in the receiver is described and illustrated in detail. Analog-to-digital (A/D) conversion and downconversion circuitry (DCC) 66 digitizes and downconverts the analog signal for digital processing. The resultant digitized signal may be used by automatic gain control circuitry (AGC) 68 to control the gain of the amplifiers in the RF circuitry 64 based on the received signal level. The digitized signal is also fed to synchronization circuitry 70 and a multiple access demodulation function 72, which will recover the incoming signal received at a corresponding antenna 40 at each receiver path. The synchronization circuitry 70 facilitates alignment or correlation of the incoming signal with the multiple access demodulation function 72 to aid recovery of the incoming signal, which is provided to a signaling processing function 74 and channel estimation function 76. The signaling processing function 74 processes basic signaling and header information to provide information sufficient to generate a channel quality measurement, which may bear on an overall signal-to-noise ratio for the link, which takes into account channel conditions and/or signal-to-noise ratios for each receive path.

The channel estimation function 76 for each receive path provides channel responses (h_{i,j}) corresponding to channel conditions for use by an STC decoder 78, if so desired or configured. The symbols from the incoming signal and channel estimates for each receive path are provided to the STC decoder 78, which provides STC decoding on each receive path to recover the transmitted symbols. The channel estimates provide sufficient channel response information to allow the STC decoder 78 to decode the symbols according to the STC encoding used by the base station 14 and recover estimates corresponding to the transmitted bits. In a preferred embodiment, the STC decoder 78 implements Maximum Likelihood Decoding (MLD) for BLAST-based transmissions. As such, the outputs of the STC decoder 78 are log likelihood ratios (LLRS) for each of the transmitted bits, as will be described below in greater detail. These estimates, such as the LLRs, are then presented to channel decoder logic 80 to recover the initially scrambled data and the CRC checksum. The channel decoder logic 80 will preferably use Turbo decoding. Accordingly, CRC logic 82 removes the CRC checksum, checks the scrambled data in traditional fashion, and provides it to the de-scrambling logic 84 for de-scrambling using the known base station de-scrambling code to recover the originally transmitted data 86.

Those skilled in the art will recognize improvements and modifications to the preferred embodiments of the present invention. All such improvements and modifications are considered within the scope of the concepts disclosed herein and the claims that follow.

What is claimed is:

1. A base station in a distributed access network comprising:
a network interface adapted to support communications with a central network controller;
a wireless communication interface adapted to support communications with a mobile terminal; and
a control system associated with the network interface and the wireless communication interface and adapted to:
receive service data units, which represent traffic for a downlink communication session with the mobile terminal, from the central network controller;
generate protocol data units from the service data units;
when the base station is one from which service for the mobile terminal is to be switched, transmit the protocol data units and associated first continuity information to the mobile terminal; and
when the base station is one to which service for the mobile terminal is switched, receive second continuity indicia from the mobile terminal; provide the protocol data units to transmit to the mobile terminal to maintain continuity of the traffic for the downlink communication session based on the second continuity indicia; and transmit the protocol data units that are provided to the mobile terminal.

2. The base station of claim 1 wherein the base station is one of a plurality of base stations in the distributed access network, and only one of the plurality of base stations in the distributed network provides service to the mobile terminal at any given time to facilitate the downlink communication session.

3. The base station of claim 2 wherein at least one of the plurality of base stations is assigned to an active set based on a relative ability to support communications with the mobile terminal, and switching occurs only between the at least one of the plurality of base stations in the active set.

4. The base station of claim 3 wherein fast cell selection is provided when there is a plurality of base stations in the active set.

5. The base station of claim 3 wherein a hard hand-off is provided when only one base station is in the active set.

6. The base station of claim 1 wherein the second continuity information is generated by the mobile terminal based on continuity indicia, which was received from a second base station from which service for the mobile terminal was switched.

7. The base station of claim 1 wherein sequence indicia is received in association with the service data units from the central network controller.

8. The base station of claim 7 wherein the first continuity information is based at least in part on the sequence indicia.

9. The base station of claim 7 wherein the second continuity information indicates at least one protocol data unit that needs to be retransmitted by the base station after switching from a second base station, which originally transmitted the at least one protocol data unit.

10. The base station of claim 9 wherein retransmission of all of the group of protocol data units associated with a certain service data unit is triggered when any of the group of protocol data units was not properly received by the mobile terminal from the second base station.

11. The base station of claim 1 wherein the first continuity indicia is embedded in at least some of the protocol data units.

12. The base station of claim 1 wherein the first continuity indicia is transmitted to the mobile terminal separate from the protocol data units.

13. The base station of claim 1 wherein the second continuity indicia is received in an acknowledgement or negative acknowledgement message sent in response to receiving or not receiving the protocol data units transmitted to the mobile terminal from another base station from which service to the mobile terminal is switched.

14. The base station of claim 1 wherein the second continuity indicia is received in a control or signaling message from the mobile terminal.

15. The base station of claim 1 wherein the control system is further adapted to provide independent scheduling of radio link resources and retransmission management.

16. The base station of claim 1 wherein the control system is further adapted to:
receive from the mobile terminal uplink protocol data units, which are uplink segmented service data units representing traffic for an uplink communication session;
generate the uplink service data units from the uplink protocol data units; and
transmit the uplink service data units to the central network controller.

17. The base station of claim 1 wherein the central network controller is a logical entity, which is centralized from the perspective of the mobile terminal.

18. The base station of claim 17 wherein the central network controller is continuously associated with the mobile terminal.

19. A base station in a distributed access network comprising:
a network interface adapted to support communications with a central network controller;
a wireless communication interface adapted to support communications with a mobile terminal; and
a control system associated with the network interface and the wireless communication interface and adapted to:
receive from the mobile terminal protocol data units, which are segmented service data units representing traffic for an uplink communication session;
generate service data units from the protocol data units; and
transmit the service data units to the central network controller.

20. The base station of claim 19 wherein when the base station is one from which service for the mobile terminal is to be switched, transmit to the central network controller any of the protocol data units from which a complete service data unit cannot be generated.

21. The base station of claim 19 wherein when the base station is one from which service for the mobile terminal is to be switched, drop any of the protocol data units from which a complete service data unit cannot be generated.

22. The base station of claim 19 wherein when the base station is one from which service for the mobile terminal is to be switched, transmit to another base station to which service for the mobile terminal is switched any of the protocol data units from which a complete service data unit cannot be generated.

23. The base station of claim 19 wherein when the base station is one to which service for the mobile terminal is to be switched, transmit to the central network controller any of the protocol data units from which a complete service data unit cannot be generated.

24. The base station of claim 19 wherein when the base station is one to which service for the mobile terminal is to be switched, drop any of the protocol data units from which a complete service data unit cannot be generated.

25. The base station of claim 19 wherein when the base station is one to which service for the mobile terminal is to be switched, transmit to another base station from which service for the mobile terminal was switched any of the protocol data units from which a complete service data unit cannot be generated.

26. The base station of claim 19 wherein the control system is further adapted to transmit to the mobile terminal feedback indicia indicating whether the protocol data units transmitted by the mobile terminal were received or not.

27. The base station of claim 19 wherein the control system is further adapted to receive continuity indicia associated with the protocol data units.

28. The base station of claim 27 wherein the continuity indicia is received in at least some of the protocol data units.

29. The base station of claim 27 wherein the continuity indicia is received in a message separate from the protocol data units.

30. The base station of claim 19 wherein the base station is one of a plurality of base stations in the distributed access network and only one of the plurality of base stations in the distributed access network provides service to the mobile terminal at any given time to facilitate the uplink communication session.

31. The base station of claim 30 wherein at least one of the plurality of base stations is assigned to an active set based on a relative ability to support communications with the mobile terminal, and switching occurs only between the at least one of the plurality of base stations in the active set.

32. The base station of claim 31 wherein fast cell selection is provided when there is a plurality of base station in the active set.

33. The base station of claim 31 wherein a hard handoff is provided when only one base station is in the active set.

34. The base station of claim 19 wherein the control system is further adapted to provide independent scheduling of radio link resources and retransmission management.

35. The base station of claim 19 wherein the central network controller is a logical entity, which is centralized from the perspective of the mobile terminal.

36. The base station of claim 35 wherein the central network controller is continuously associated with the mobile terminal.
